(19) United States
(12) Patent Application Publication
(10) Pub. No.: US 2009/0017281 A1
(43) Pub. Date: Jan. 15, 2009

(54) Sequestered carbon dioxide glass and the use thereof

(75) Inventor: Hsiao-Yuan Li, (US)

Correspondence Address: Hsiao-Yuan Li, Suite B2, 100 S. Bowser Road, Richardson, TX, 75081-4301, US

(73) Assignee: 21-Century Silicon, Inc.

(21) Appl. No.: 11/825,747

(22) Filed: Jul. 9, 2007

(51) Int. Cl. B32B 3/26

(52) U.S. Cl. 428/304.4

(57) ABSTRACT

A lighter-than-water glass construction material containing embedded carbon dioxide bubbles is manufactured by concentrated reflective solar heating on mixture of sand, sodium bicarbonate, and limestone. The melt is allowed to solidify without permitting the carbon dioxide and water vapor to escape. The material is primarily used to build large size floating ponds for marine vegetation growth in an ammonium chloride fertilized seawater environment for atmospheric carbon dioxide capture via biomass photosynthesis sequestration.

### BACKGROUND OF THE INVENTION

1. Field of the Invention

The present invention lies in the field of glass making, and more specifically, to make lighter-than-water glass with sequestered carbon dioxide embedded therein, for use in the field of climate control technology.

2. Description of the Related Art

United State burns annually close to one billion tons of coal for power generation. China and India burn nearly the same amount and may soon surpass United States. Expert reports stated that severe consequence may expected from uncontrolled anthropogenic carbon dioxide emission. United States Department of Energy has successfully demonstration projects that are capable to absorb better than 99 percent of carbon dioxide by scrubbing the after-burning flue gas with low molecular weight amines. The amines are recycled by steam separation, which consumes significant amount of energy, and the high concentration carbon dioxide after separation compressed in liquid form, known as final sequestration, stored underground or used for enhancing crude oil production. Reports on amine scrubbing indicate that at least 40% cost increase per kWh is expected circa 2005. Consequently, large scale amine scrubbing is unpractical.

Patent application titled “System and method for carbon dioxide double sequestration” was filed on May 10, 2007 and received application Ser. No. 11/801,619. It calls for employing ammonia instead of amine for flue gas carbon dioxide capture without recycling ammonia for reuse. Solvay styled scrubber using ammoniated brine is installed to remove carbon dioxide from flue gas at approximately the same capture rate as amine scrubbing. The process produces sodium bicarbonate 7 times the weight of coal, and ammonium chloride, a nitrogen fertilizer good for heavy rainfall area or ocean vegetation growth, 4.46 times the weight of the coal. The process also consumes ammonia in 1.42 times the weight of coal. If all anthropogenic carbon dioxide are captured in the future, the quantities of baking soda, ammonium chloride, and ammonia are hundreds times greater than the current world market. Since the weight of biomass produced by photosynthesis can be hundreds times the weight of ammonium chloride fertilizer applied, “Carbon Dioxide Double Sequestration” is economically feasible and is the only technology of this magnitude that can reverse the carbon dioxide concentration back to the 1950 level, after many decades of practice, and the biomass so produced has economic value to support this innovation. This present invention addresses the need to channel the immense amount of sodium bicarbonate so produced for a good usage as raw material to produce glass contains sequestrated carbon dioxide embedded useful as construction material for the immensely large new sequestration industry.

The worldwide production for soda ash in 2005 was at 41.9 million metric tons, and the worldwide production for ammonia in the same year was 121.0 million metric tons. According to Energy Information Administration, in 2000, 24 billion metric tons per year of carbon dioxide were added to the earth atmosphere. Even with Carbon Dioxide Double Sequestration Technology available, it will take human society many decades to see some measurable results on atmospheric level of carbon dioxide reduction. A Petition was filed to Secretary Samuel W. Bodman, The U.S. Department of Energy to include this technology presented in this application for discussion in the Agenda of coming International Conference for working out a plan to replace Kyoto Protocol. The information presented in this application can greatly reduce the concerns and objections the delegates of the Conference may bring forward.

It is known that glass can be made using silica as its only component. Such glass melts at very high temperature. A group of compounds known as flux are added to reduce melting temperature for easier processing. The most common one is sodium carbonate, sodium bicarbonate, or a combination thereof. However, glass made of sand and soda ash can dissolve slowly in water, consequently, a group of compounds known as property modifiers are added to obtain the desired property. The most common modifier at low cost is lime stone. It is well known to persons skilled in the art that glass melts below 550.sup.oC can be produced. The selected temperature is easily obtainable by reflective parabolic mirrors known as CSP, concentrated solar power. During the smelting process, large amount of carbon dioxide are generated from the reaction mix. Typically 12 to 20 weight percent loss for a commercial melt. The glass industry sometimes has to allow six hours to let carbon dioxide escape before next step of processing takes place, since bubbles embedded inside glass is consumer unacceptable. A class of compound known as fining agents is added to speed up the removal of bubbles.

In this invention, the goal is to consume the largest quantity possible on sodium bicarbonate the flux material, and to produce glass product of sufficient strength to be used as building material to construction facilities far-off-shore for carbon dioxide capture without excessive maintenance, the long human history of enamel coated porcelain taught us this prior art can be useful to achieve this purpose.

### SUMMARY OF THE INVENTION

It is therefore an objective of the present invention to keep the carbon dioxide generated during glass making embedded in the matrix without letting escape into the atmosphere. The present invention aims to develop a new class of building material with specific gravity less than 1 that can be used to construct very large containers floating in the midst of oceanic areas far from the shore lines, wherein originally has very little marine vegetation growth. This large oceanic surface consequently contributes very un-effectively on carbon dioxide capture via photosynthesis without the deployment of the technology addressed in this invention. The large containers so constructed will keep the ammonium chloride fertilizer being washed away as well as keep the vegetation grown herein in place for harvesting as biomass fuel, completing the carbon dioxide recycling loop.

Another objective of the present invention is to use concentrated solar heat to provide the energy required in glass making without burning additional fossil fuel, or in other words, without introducing additional carbon dioxide emission. Computer controlled tracking reflective mirror systems can easily produce hot zone with temperature around 550.sup.oC, well above the liquefying temperature of soft sodium-calcium glass. This objective of the present invention, without using fossil melted glass, enhances the “greenness” of the overall carbon dioxide sequestration project to a new high standard. However, it is not the objective of this invention to use concentrated solar power to coat enamel around the glass block.

### BRIEF DESCRIPTION OF THE DRAWINGS

FIG. 1 shows a floating glass structure immobilized as an aquamarine farm.

FIG. 2 shows a sun light reflective heating system for melting glass embedded with carbon dioxide bubbles.

### DETAILED DESCRIPTION OF THE INVENTION

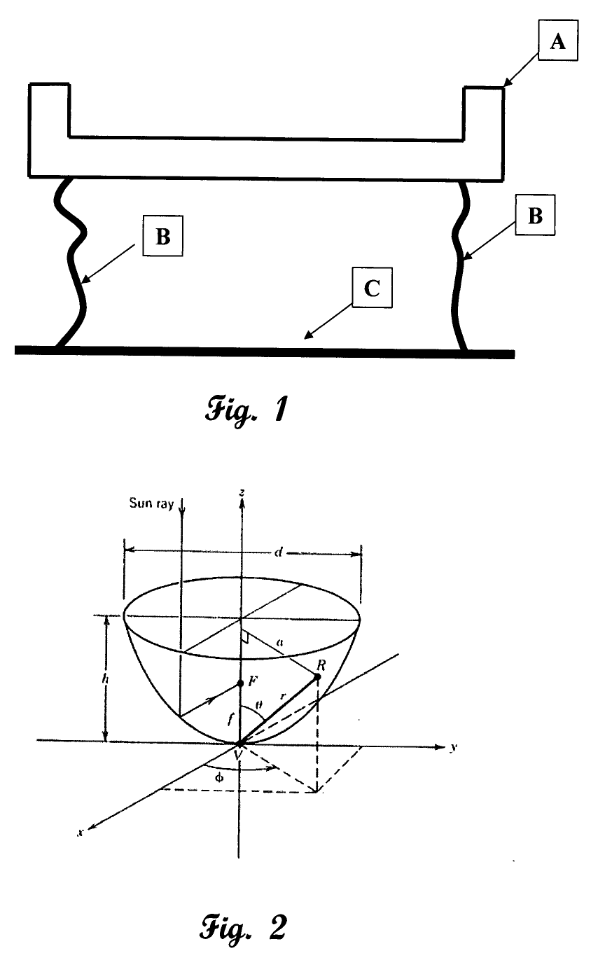

Referring to FIG. 1, A points to the floating aquamarine farm made of lighter-than-water glass material embedded with carbon dioxide bubbles coming from the chemical reactions
2 NaHCO.sub.3+SiO.sub.2→Na.sub.2SiO.sub.3+2 CO.sub.2+H.sub.2O, and
CaCO.sub.3+SiO.sub.2→CaSiO.sub.3+CO.sub.2 (not in molar proportion)
The carbon dioxide is trapped inside the glass matrix purposely. The water vapor co-trapped in the structure shall appear as liquid droplets at the ambient conditions at the sea level.
The size of the floating aquamarine farm A can range from the size of basketball field to several hundred meters on each side, with supporting equipment rooms (not shown in the drawing) such as pumping facility, biomass harvesting facility, biomass drying facility, biomass package facility, and shipping port, etc as required. FIG. 1 also shows a multitude of anchoring means B attached to the ocean bottom C to immobilize the aquamarine farm.

Referring to FIG. 2, F is the location of focal point of a paraboloidal reflective mirror solar heater that is capable to concentrate incoming sun ray to at least 550.sup.o Centigrade in volumetric region around F. Parabolic trough reflective mirror is an alternative means that serves the same function of heating by concentrated solar power (CSP). Both the paraboloid and the parabolic trough can be approximated by using a multitude of smaller pieces of flat reflective mirrors. A computer controlled tracking system, not shown in FIG. 2, is aiming the [symbol] direction in parallel to the sunray. Also not shown in FIG. 2, means to load feedstock powders as well as means to unload carbon dioxide entrapped glass melts are provided in the reflective solar heating system.

Conventional enamel coating means are employed to cover the blocks of lighter-than-water building structures for erosion protection.

What is claimed is:

1. A new lighter-than-water construction material comprising,
Soft sodium lime glass;
Entrapped carbon dioxide and water vapor bubbles embedded therein said soft glass; and
Enamel coating over said soft glass to protect said soft glass from erosion loss in contact with ocean water.

2. The construction material according to claim 1, wherein said soft glass is formulated to melt below 550 degree Centigrade as reachable by reflective mirror solar heating systems.

3. The soft glass according to claim 2, wherein the melting is carried over with concentrated solar heating in lieu of fossil heating.

4. The construction material according to claim 1, wherein the use thereof is to construct aquamarine farm enclosures for photosynthesis capture of atmospheric carbon dioxide in far offshore oceanic region.

5. The farm enclosure recited in claim 4, wherein ammonium chloride solution is applied as nitrogen fertilizer inside said enclosure for economic growth of marine vegetation without leakage.

6. The farm enclosure recited in claim 4, wherein the marine vegetation is confined for biomass harvesting.
